(19) United States
(12) Patent Application Publication
(10) Pub. No.: US 2010/0122925 A1
(43) Pub. Date: May 20, 2010

(54) SYRINGE DISPOSAL UNIT

(76) Inventors: Joan Charbonneau, Chester, NJ (US); David Matthew Zeanah, Knoxville, TN (US)

Correspondence Address: KANG INTELLECTUAL PROPERTY LAW, LLC, 214 ELM STREET, SUITE 106, WASHINGTON, MO, 63090, US

(21) Appl. No.: 12/273,070

(22) Filed: Nov. 18, 2008

(51) Int. Cl. A61J 1/14; B65D 25/02

(52) U.S. Cl. 206/370; 220/735

(57) ABSTRACT

This invention presents a syringe disposal unit for disposal of used disposable syringe needle assemblies of a reusable syringe. The syringe disposal includes a container having an interior for receiving a needle assembly of a reusable syringe. The needle assembly is removable from a syringe body of the reusable syringe. The container also has a through-hole through which the needle assembly can enter the interior. The syringe disposal also includes a needle base latch movable between an engaging position and a disengaging position. When the needle assembly is positioned in the through-hole the needle base latch contacts the needle assembly in the engaging position in such a way that the needle base latch prevents the needle assembly from rotating relative to the container, while the needle base latch does not contact the needle assembly in the disengaging position in such a manner that the needle base latch does not prevent the needle base from rotating relative to the container.

### CROSS-REFERENCE TO RELATED APPLICATIONS

Not Applicable.

### STATEMENT REGARDING FEDERALLY SPONSORED RESEARCH OR DEVELOPMENT

Not Applicable.

### APPENDIX

Not Applicable.

### FIELD OF THE INVENTION

This invention generally relates to disposal units for safely disposing of used medical instruments and, more particularly, to a syringe disposal unit for safely disposing of used syringe needles of a reusable or multi-dose syringe.

### BACKGROUND OF THE INVENTION

Many patients must administer multiple doses of medication daily. Reusable or multi-dose injectors, such as reusable syringes or pen-type injectors, have been widely used for daily administration of medication. However, needles, after a use on a patient, become contaminated and create a hazard for anyone that may handle them following their use because of the chance of being accidentally stuck by these contaminated needles. In addition, the contaminated needles may become a deadly transmitter of infectious diseases, such as Acquired Immune Deficiency Syndrome (AIDS), hepatitis or the like. Accordingly, the used needle must be removed from the multi-dose syringe or pen-type injector, and then safely disposed of in a specially designed container in order to prevent accidental transmittal of infectious diseases, or intentional and/or illegal needle reuse. The containers are then collected and discharged at a separated collection point for ultimate disposal of the needles.

Multi-dose syringes or pen-type injectors include a syringe body for storing the medication, and a needle assembly for transferring the medication via a needle. Needle assemblies usually include a needle, and a needle base that can be mounted onto the syringe body. The needle and needle base may be integrally formed. In many multi-dose syringe designs, needle bases have a threaded portion that can mesh with a threaded portion of the syringe body so that the needle assembly can be screwed to and unscrewed from the syringe body.

Syringe disposal containers are known and examples of such containers are shown in the following specifications: U.S. Pat. No. 6,250,465, U.S. Pat. No. 6,142,303, and U.S. Pat. No. 5,848,692. These containers employ designs that allow syringes to be placed within the container while preventing them from being accidentally or intentionally removed out of the containers. However, these containers are all designed for disposal of used syringes as a whole. Accordingly, these containers are not specifically suitable for disposal of needle assemblies of reusable syringes where the used needle assemblies must be removed from the reusable syringes.

Examples of syringe containers especially designed for disposal of used needle assemblies removed from the reusable syringes are shown in U.S. Pat. No. 6,253,916, U.S. Pat. No. 6,247,592, U.S. Pat. No. 6,024,216, U.S. Pat. No. 5,829,588, and U.S. Pat. No. 5,603,404. These designs employ notches, slots or gear-like teeth that can engage with the needle base, preventing it from rotating so that the needle assembly can be unscrewed from the syringe body by twisting the syringe body portion. However, the needle assemblies removed from the syringe body may be stuck with the notches, slots or teeth. Designs shown in U.S. Pat. No. 6,971,516 and U.S. Pat. No. 6,923,318 employ ribs formed on the inner surface of the openings to prevent the needle base from rotating. However, these designs cannot be used for needle assemblies in general. In other words, they can only be used for needle bases with specific diameters, and specific patterns of grooves formed on the outer surface thereof. In addition, in designs shown in U.S. Pat. No. 6,062,001 and U.S. Pat. No. 5,857,569, parts for gripping the needle base are made of flexible material so that the removed needle assemblies can only pass through the openings by being forcedly pushed down therethrough.

General problem with the known disposal containers is that it is difficult to provide a container that is easy to use to remove used needle assemblies from the reusable syringe and to safely dispose of them therein.

### SUMMARY OF THE INVENTION

Accordingly, the present invention has been made to solve the above-mentioned problems occurring in the prior art, and it is an object of the present invention to provide a syringe disposal unit that can be used with various reusable syringe designs. It is another object of the present invention to provide a syringe disposal unit that can be easily used to remove used needle assemblies from the reusable syringe and to safely dispose of them therein.

To achieve the above object, according to the present invention, there is provided a syringe disposal unit for disposal of used disposable needle assemblies of a reusable syringe. The syringe disposal unit includes a container having an interior space for receiving a needle assembly of a reusable syringe, which needle assembly includes a needle and a needle base and is removably screwed to a syringe body of the reusable syringe. The container has a through-hole through which the needle assembly can enter the interior. The syringe disposal unit also includes a needle base latch that is movable between an engaging position and a disengaging position. The needle base latch has a contact surface. When the needle assembly is positioned in the through-hole, the contact surface contacts the needle assembly in the engaging position in such a way that the needle base latch prevents the needle assembly from rotating. In the disengaging position the contact surface does not contact the needle assembly.

In a preferred embodiment, the syringe disposal unit according to the present invention can also include a controller operatively connected with the needle base latch for moving the needle base latch between the engaging position and the disengaging position. In a preferred embodiment, the controller can be a push button. Preferably, when the push button is pressed the needle base latch is moved to the engaging position, and when the push button is released the needle base latch is moved to the disengaging position.

Additionally or alternatively, in a preferred embodiment, the needle base latch can be biased toward the disengaging position. Additionally or alternatively, the needle base latch can preferably have a ridge or groove in the contact surface.

In a preferred embodiment, the syringe disposal unit according to the present invention can include a cover movable between an opening position and a closing position. In the closing position the cover covers the through-hole, and in the opening position the cover does not cover the through-hole. In a preferred embodiment, the cover is slidingly movable between the opening position and the closing position. Preferably, the syringe disposal unit can also include a cover latch for releasably locking the cover in the opening position. Additionally or alternatively, the syringe disposal unit can include a cover latch for releasably locking the cover in the closing position. Additionally or alternatively, in a preferred embodiment, the cover can have an arrow pointing toward the opening position. Additionally or alternatively, the cover can be biased toward the closing position.

In a preferred embodiment, the syringe disposal unit according to the present invention can also include a needle assembly holder movable between a holding position and a releasing position. In the holding position the needle assembly holder prevents the needle assembly from passing through the through-hole. In the releasing position the needle assembly holder allows the needle assembly to pass through the through-hole. In a preferred embodiment, the needle assembly holder is slidingly movable between the holding position and the releasing position. In a preferred embodiment, the syringe disposal unit can also include a controller operatively connected with the needle assembly holder for moving the needle assembly holder between the holding position and the releasing position. Additionally or alternatively, the needle assembly holder can be biased toward the holding position.

In a preferred embodiment, the needle base latch can be designed in such a way that the needle base latch is in the disengaging position when the needle assembly holder is in the holding position, and the needle assembly holder is in the releasing position when the needle base latch is in the engaging position.

In a preferred embodiment, the through-hole can be sized so as to provide a small clearance between the needle assembly and the inner wall of the through-hole. Additionally or alternatively, the through-hole can be sized such that the through-hole prevents the syringe body from passing therethrough while allowing the needle assembly to pass therethrough.

In a preferred embodiment, the interior can be sized to receive a plurality of the needle assemblies. Preferably, the container can have a viewing window. In a preferred embodiment, the syringe disposal unit is portable.

In a preferred embodiment, the container can include a top portion, a sidewall portion, and a bottom portion. The top portion is preferably fixedly attached to the sidewall portion, and the sidewall portion is preferably integrally formed with the bottom portion.

Further areas of applicability of the present invention will become apparent from the detailed description provided hereinafter. It should be understood that the detailed description and specific examples, while indicating the preferred embodiment of the invention are intended for purposes of illustration only and are not intended to limit the scope of the invention.

### BRIEF DESCRIPTION OF THE DRAWINGS

The above and other objects and features of the present invention will become apparent from the following description of preferred embodiments given in conjunction with the accompanying drawings, in which:

FIG. 1 is a perspective view of an example of reusable or multi-dose syringe or pen-type injectors for which a syringe disposal unit according to the present invention can be used.

FIG. 2 is a perspective view of an embodiment of a syringe disposal unit according to the present invention.

FIG. 3 is a top view of the syringe disposal unit of FIG. 2 where a sliding cover is in a closing position.

FIG. 4 is a top view of the syringe disposal unit of FIG. 2 where the sliding cover is in an opening position such that a through-hole of the syringe disposal unit can be seen.

FIG. 5 is a perspective view of the syringe disposal unit of FIG. 2 with the sliding cover in the opening position, where a syringe is placed such that the disposable needle assembly of the syringe is positioned within the through-hole of the syringe disposal unit.

FIG. 6 is a top view of the syringe disposal unit of FIG. 2 where a push button is pressed and a needle base latch is in an engaging position where the needle base latch protrudes out of the inner wall of the through-hole toward the center thereof, with the sliding cover in the opening position.

FIG. 7 is a top view of an embodiment of a syringe disposal unit according to the present invention, with a sliding cover in an opening position, with a push button released, and with a needle assembly holder in a holding position where the needle assembly holder protrudes out of the inner wall of the through-hole toward the center thereof.

FIG. 8 is a perspective view of the syringe disposal unit of FIG. 7 where a disposable needle assembly is removed from the syringe and held in the through-hole of the syringe disposal unit.

### DETAILED DESCRIPTION OF THE INVENTION

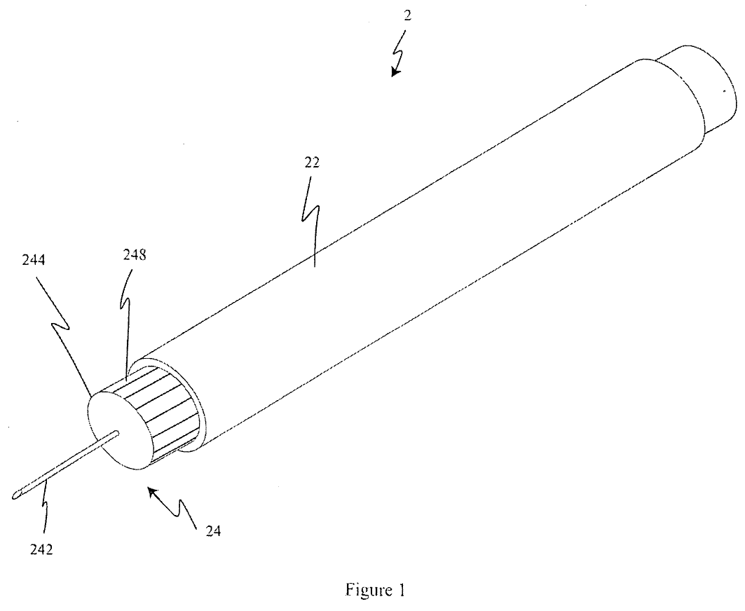

Shown in FIG. 1 is an example of reusable or multi-dose syringes or pen-type injectors for which a syringe disposal unit accordingly to the present invention can be used. The syringe 2 has a syringe body 22 providing an interior chamber for storing multi-dose fluid medication therein. The syringe 2 also has a disposable needle assembly 24 attached to the syringe body 22 so as to enclose the interior chamber. The disposable needle assembly 24 has a hollow needle 242, and a needle base 244 holding and securing the hollow needle 242 that extends therethrough in a longitudinal direction. The hollow needle 242 may be integrally formed with the needle base 244. The needle base 244 is usually smaller than the syringe body 22 in diameter as shown.

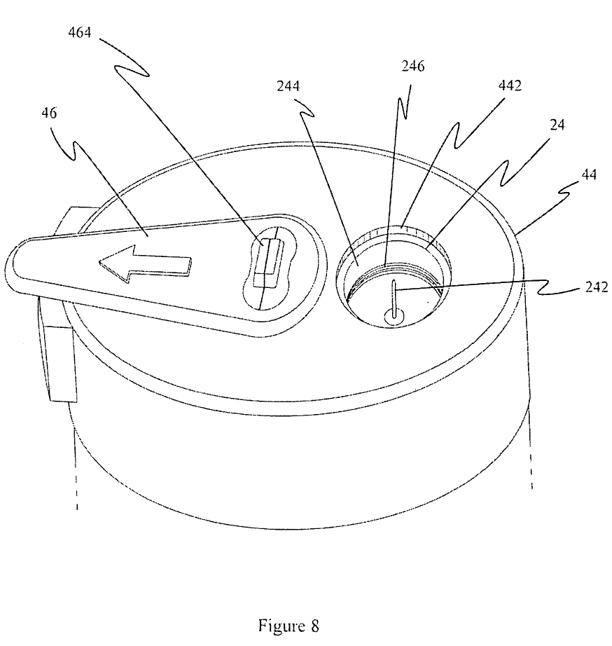

The needle base 244 has a threaded inner surface 246 as shown in FIG. 8. The syringe body 22 has a threaded outer surface (not shown) at its end portion, which can engage with the threaded inner surface 246 of the needle base 244. Alternatively, it may also be possible that the needle base 244 has a threaded outer surface at its end portion that can engage with a threaded inner surface of the syringe body 22. In this way, the disposable needle assembly 24 can be removably screwed to the syringe body 22. After using the syringe 2, a user can unscrew and remove the disposable needle assembly 24 from the syringe body 22 by twisting one of the syringe body 22 and the needle assembly 24 while holding the other. The disposable needle assembly 24 can also have a protective needle cap (not shown) that can be removably attached to the needle base 244 so as to cover and protect the hollow needle 242 when not used.

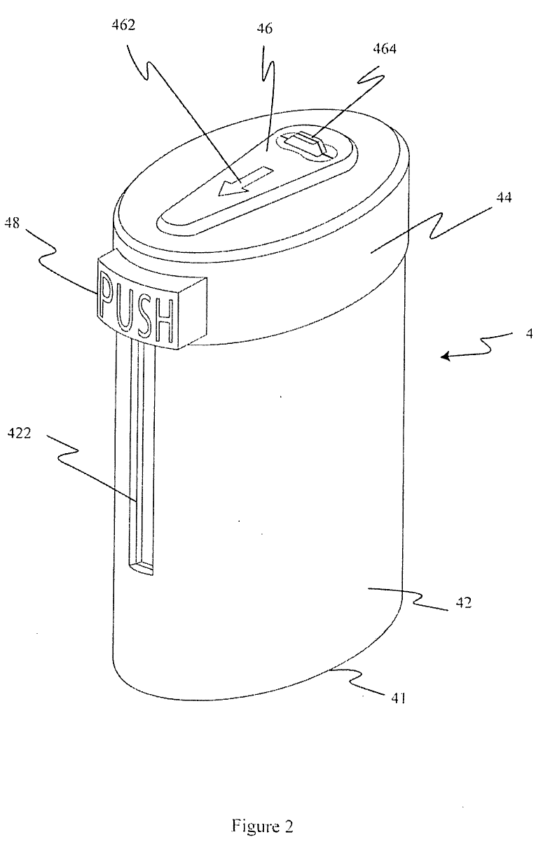

FIG. 2 shows an embodiment of a syringe disposal unit 4 according to the present invention, which can be used for the syringe 2 as shown in FIG. 1. The syringe disposal unit 4 has a container including a bottom portion 41, a sidewall portion 42, and a top portion 44. The bottom portion 41 and the sidewall portion 42 together provide an interior space therein for accommodating the disposable needle assemblies 24 that have been removed from the syringe body 22. The top portion 44 of the syringe disposal unit 4 is attached on to the sidewall portion 42 so as to enclose the interior space. The top portion 44 has a through-hole 442, as shown in FIG. 4, for providing access to the interior space of the syringe disposal unit 4 for disposing of used disposable needle assemblies 24. The interior space is large enough to accommodate a number of disposable needle assemblies 24. The interior space can preferably accommodate thirty disposable needle assemblies 24. The interior space can be designed to accommodate a larger number of disposable needle assemblies 24, for example sixty or ninety disposable needle assemblies 24. However, preferably, the overall size of the syringe disposal unit 4 is small enough so that the syringe disposal unit 4 can be portable. The bottom portion 41, the sidewall portion 42, and the top portion 44 are all preferably made of puncture resistant and leak-proof material.

The bottom portion 41 and the sidewall portion 42 are preferably integrally formed. The top portion 44 is preferably fixedly attached on to the sidewall portion 42 such that home users usually cannot detach the top portion 44 from the other portions 41, 42. This promotes the integrity of the syringe disposal unit 4, and also helps prevent the used disposable needle assemblies 24 from becoming easily available for illegal purposes.

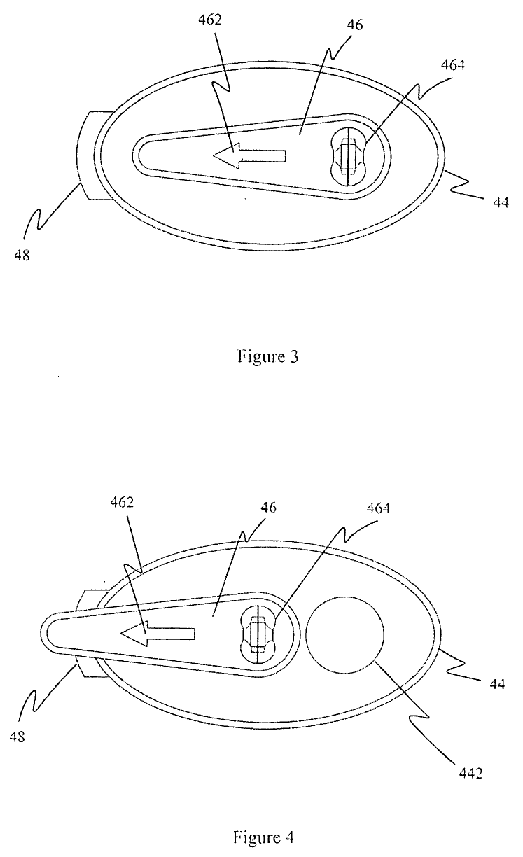

In a preferred embodiment, a sliding cover 46 is slideably attached on to the top portion 44 of the syringe disposal unit 4. Preferably, the sliding cover 46 is manually moved between a closing position as shown in FIG. 3 and an opening position as shown in FIG. 4. The sliding cover 46 can preferably have an arrow 462 on the top surface thereof, pointing toward the opening position. The sliding cover 46 can preferably have a protrusion 464, which can facilitate the sliding movement of the sliding cover 46 when a user tries to move the sliding cover 46 with his/her finger.

As shown in FIG. 4, in order to provide access to the interior space for disposal of the disposable needle assemblies 24, the top portion 44 of the syringe disposal unit 4 has a through-hole 442, through which the disposable needle assemblies 24 can pass. When the sliding cover 46 is in the closing position as shown in FIG. 3, the through-hole 442 is completely covered by the sliding cover 46 so that disposable needle assemblies 24 are prevented from passing therethrough. When the sliding cover 46 is in the opening position as shown in FIG. 4, the through-hole 442 is uncovered so that the used disposable needle assemblies 24 can now pass therethrough into the syringe disposal unit 4.

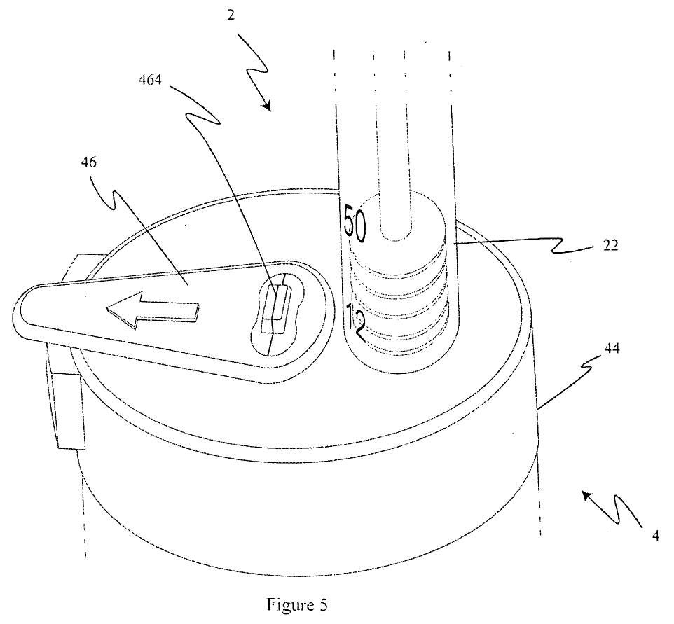

In a preferred embodiment, the through-hole 442 is generally circular as shown. The through-hole 442 is preferably larger than the disposable needle assembly 24 but smaller than the syringe body 22 in diameter, allowing the disposable needle assembly 24 to pass through the through-hole 442 while preventing the syringe body 22 from passing therethrough as can be seen in FIG. 5. The through-hole 442 is preferably slightly larger than the disposable needle assembly 24 so that there is only a small clearance between the disposable needle assembly 24 and the inner wall of the through-hole 442. This can help prevent disposable needle assemblies 24 contained in the syringe disposal unit 4 from being accidentally released even when the sliding cover 46 is in the opening position.

In a preferred embodiment, a spring (not shown) is operatively attached to the sliding cover 46 so as to bias the sliding cover 46 toward the closing position. This can help prevent the spring cover 46 from being unintentionally opened, and thus further prevent accidental releasing of disposable needle assemblies 24 out of the syringe disposal unit 4. Additionally or alternatively, the syringe disposal unit 4 has a releasable latch mechanism (not shown) that can hold the sliding cover 46 in the opening position. The latch mechanism is preferably easily releasable such that a slight force can overcome the latch mechanism so as to return the sliding cover 46 back to the closing position. Additionally or alternatively, the syringe disposal unit 4 can also have a releasable latch mechanism (not shown) that can lock the sliding cover 46 in the closing position.

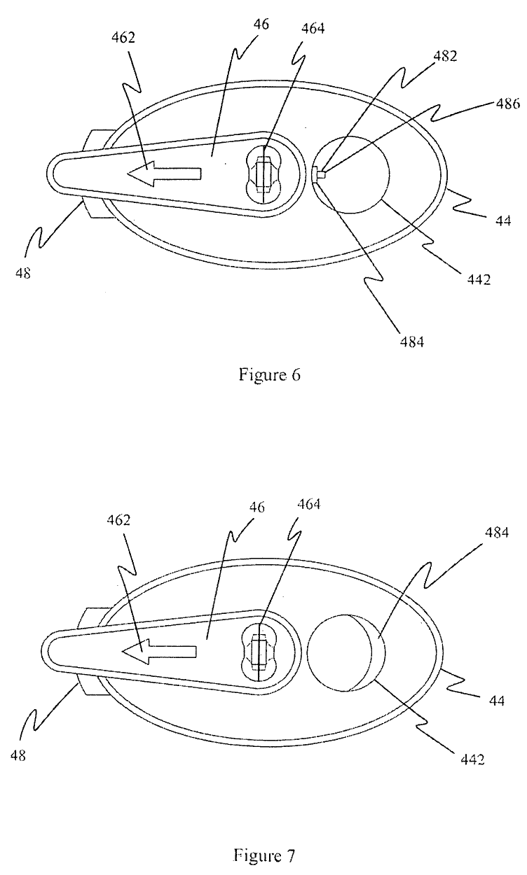

In a preferred embodiment of the present invention, the syringe disposal unit 4 has a push button 48 installed on to the lateral surface of the top portion 44. When the push button 48 is pressed, a needle base latch 482 is slidingly moved to an engaging position where the needle base latch 482 protrudes out of the inner wall of the through-hole 442 toward the center thereof as shown in FIG. 6. When the disposable needle assembly 24 is positioned in the through-hole 442, in the engaging position a distal end surface 484 of the needle base latch 482 can contact the outer circumferential surface of the needle base 244 and frictionally prevent the disposable needle base 244 from rotating. Accordingly, a user can unscrew the disposable needle assembly 24 from the syringe body 22 by rotating the syringe body 22 while pressing the push button 48.

As shown in FIG. 7, when the push button 48 is released, the needle base latch 482 is slidingly moved back to a disengaging position where the needle base latch 482 is retracted in to the inner wall of the through-hole 442. Accordingly, in the disengaging position, the distal end surface 484 of the needle base latch 482 cannot contact the needle base 244.

Preferably, the needle base 244 of the disposable needle assembly 24 can have grooves or ridges 248 on its outer circumferential surface, as shown in FIG. 1. This can facilitate the engagement between the needle base latch 482 and the needle base 244, and thus help further prevent the disposal needle assembly 24 from rotating in the engaging position. As shown in FIG. 6, the needle base latch 482 can also have grooves or ridges 486 in the distal end surface 484, which can engage with the grooves or ridges 248 of the needle base 244. In a preferred embodiment, the needle base latch 482 is biased such that when the push button 48 is released, the needle base latch 482 is moved to a disengaging position where the needle base latch 482 is retracted into the inner wall of the through-hole 442 and the distal end surface 484 cannot contact the needle base 244.

As shown in FIG. 7, in a preferred embodiment, the syringe disposal unit 4 has a needle assembly holder 484 movably installed on to the inner wall of the through-hole 442. The needle assembly holder 484 can be slidingly moved between a holding position as shown in FIG. 7 and a releasing position as shown in FIG. 6. In the holding position, the needle assembly holder 484 protrudes out of the inner wall of the through-hole 442 such that it prevents the disposable needle assembly 24 from falling into the inner space of the syringe disposal unit 4. FIG. 8 shows a detached disposable needle assembly 24 held within the through-hole 442 by the needle assembly holder 484. In the releasing position, the needle assembly holder 484 is retracted into the inner wall of the through-hole 442 such that it now allows the disposable needle assembly 24 to fall into the inner space through the through-hole 442.

In a preferred embodiment, the needle assembly holder 484 is moved to the holding position when the push button 48 is released while the needle assembly holder 484 is moved to the releasing position when the push button 48 is pressed. Preferably, when the push button 48 is half pressed, neither the needle assembly holder 484 nor the needle base latch 482 protrudes out of the inner wall of the through-hole 442 so that the needle assembly 24 can fall down into the interior space without interference. Preferably, the needle assembly holder 484 is biased toward the holding position by a spring (not shown). This can further help prevent the disposable needle assemblies 24 from being inadvertently released through the through-hole 442.

In a preferred embodiment, the sidewall portion 42 has a viewing window 422 made of puncture resistant material to permit visual observation of the amount of disposable needle assemblies 24 within the inner space of the syringe disposal unit 4.

As various modifications could be made to the exemplary embodiments, as described above with reference to the corresponding illustrations, without departing from the scope of the invention, it is intended that all matter contained in the foregoing description and shown in the accompanying drawings shall be interpreted as illustrative rather than limiting. Thus, the breadth and scope of the present invention should not be limited by any of the above-described exemplary embodiments, but should be defined only in accordance with the following claims appended hereto and their equivalents.

What is claimed is:

1. A syringe disposal unit for disposal of used disposable needle assemblies of a reusable syringe, comprising:
a container having an interior space for receiving a needle assembly of a reusable syringe, the needle assembly including a needle and a needle base, the needle assembly being removably screwed to a syringe body of the reusable syringe, wherein said container has a through-hole through which the needle assembly can enter said interior;
a needle base latch movable between an engaging position and a disengaging position, said needle base latch having a contact surface, wherein when the needle assembly is positioned in said through-hole, in said engaging position said contact surface of said needle base latch contacts the needle assembly in such a way that said needle base latch prevents the needle assembly from rotating, while in said disengaging position said contact surface of said needle base latch does not contact the needle assembly.

2. The syringe disposal unit of claim 1 further comprising:
a controller operatively connected with said needle base latch for moving said needle base latch between said engaging position and said disengaging position.

3. The syringe disposal unit of claim 2, wherein said controller comprises a push button, wherein when said push button is pressed said needle base latch is moved to said engaging position, and wherein when said push button is released said needle base latch is moved to said disengaging position.

4. The syringe disposal unit of claim 1, wherein said needle base latch is biased toward said disengaging position.

5. The syringe disposal unit of claim 1, wherein said needle base latch has a ridge or groove in said contact surface.

6. The syringe disposal unit of claim 1 further comprising:
a cover movable between an opening position and a closing position, wherein in said closing position said cover covers said through-hole, and wherein in said opening position said cover does not cover said through-hole.

7. The syringe disposal unit of claim 6, wherein said cover is slidingly movable between said opening position and said closing position.

8. The syringe disposal unit of claim 6, further comprising:
a cover latch for releasably locking said cover in said opening position.

9. The syringe disposal unit of claim 6, further comprising:
a cover latch for releasably locking said cover in said closing position.

10. The syringe disposal unit of claim 6, wherein said cover has an arrow pointing toward said opening position.

11. The syringe disposal unit of claim 6, wherein said cover is biased toward said closing position.

12. The syringe disposal unit of claim 1, further comprising:
a needle assembly holder movable between a holding position and a releasing position, wherein in said holding position said needle assembly holder prevents the needle assembly from passing through said through-hole, and wherein in said releasing position said needle assembly holder allows the needle assembly to pass through said through-hole.

13. The syringe disposal unit of claim 12, wherein said needle assembly holder is slidingly movable between said holding position and said releasing position.

14. The syringe disposal unit of claim 12, further comprising:
a controller operatively connected with said needle assembly holder for moving said needle assembly holder between said holding position and said releasing position.

15. The syringe disposal unit of claim 12, wherein said needle assembly holder is biased toward said holding position.

16. The syringe disposal unit of claim 12, wherein said needle base latch is in said disengaging position when said needle assembly holder is in said holding position, and wherein said needle assembly holder is in said releasing position when said needle base latch is in said engaging position.

17. The syringe disposal unit of claim 1, wherein said through-hole is sized so as to provide a small clearance between the needle assembly and the inner wall of said through-hole.

18. The syringe disposal unit of claim 1, wherein said through-hole is sized such that said through-hole prevents the syringe body from passing therethrough while allowing the needle assembly to pass therethrough.

19. The syringe disposal unit of claim 1, wherein said interior is sized to receive a plurality of said needle assemblies.

20. The syringe disposal unit of claim 1, wherein said container has a viewing window.

21. The syringe disposal unit of claim 1, wherein said container comprises a top portion, a sidewall portion, and a bottom portion, said top portion being fixedly attached to said sidewall portion, and said sidewall portion being integrally formed with said bottom portion.

22. The syringe disposal unit of claim 1, wherein said syringe disposal unit is portable.
